(19) United States
(12) Patent Application Publication
(10) Pub. No.: US 2018/0232612 A1
(43) Pub. Date: Aug. 16, 2018

(54) DYNAMIC MAGNETIC STRIPE COMMUNICATIONS DEVICE FOR CARDS AND DEVICES

(71) Applicant: Dynamics Inc., Cheswick, PA (US)

(72) Inventors: James H. Workley, Imperial, PA (US); Jun Yu, Pittsburgh, PA (US); Allen D. Bowers, Aspenwall, PA (US)

(21) Appl. No.: 15/709,819

(22) Filed: Sep. 20, 2017

Related U.S. Application Data
(60) Provisional application No. 62/385,400, filed on Sep. 9, 2016.

(51) Int. Cl. G06K 19/06

(52) U.S. Cl. CPC G06K 19/06206; G06K 19/06196

(57) ABSTRACT

A device, such as a flexible card, may include a dynamic magnetic stripe emulator operable to transmit magnetic stripe information, a first magnet adjacent to a first side of the dynamic magnetic stripe emulator, and a second magnet adjacent to a second side of the dynamic magnetic stripe emulator.

### BACKGROUND OF THE INVENTION

This invention relates to cards and devices and associated payment systems.

### SUMMARY OF THE INVENTION

A device, such as a card, smart phone, mobile phone, tablet, FOB, RFID device, may include a dynamic magnetic stripe communications device. Such a dynamic magnetic stripe communications device may take the form of a magnetic encoder or an electromagnetic generator. A magnetic encoder may change the information located on a magnetic medium such that a magnetic stripe reader may read changed magnetic information from the magnetic medium. An electromagnetic generator may generate electromagnetic fields that directly communicate data to a magnetic stripe reader. Such an electromagnetic generator may communicate data serially to a read-head of the magnetic stripe reader.

All, or substantially all, of the front as well as the back of a device may be a display (e.g., bi-stable, non bi-stable, LCD, or electrochromic display). Electrodes of a display may be coupled to one or more capacitive touch sensors such that a display may be provided as a touch-screen display. Any type of touch-screen display may be utilized. Such touch-screen displays may be operable of determining multiple points of touch. A barcode, for example, may be displayed across all, or substantially all, of a surface of a device. In doing so, computer vision equipment such as barcode readers may be less susceptible to errors in reading a displayed barcode.

A display, for example made of e-paper, may be fabricated directly onto the printed circuit board, for example a flexible printed circuit board. In addition, the display driver may be replaced with FETs. For example, each FET may be operable to control one segment of the display. In this manner generic hardware (for example e-paper for the display and FETs for the display driver) may replace dedicated hardware, providing more flexibility, for example with regard to in sourcing materials.

A device may include a number of output devices to output dynamic information. For example, a device may include one or more RFIDs or IC chips to communicate to one or more RFID readers or IC chip readers, respectively. A device may include devices to receive information. For example, an RFID and IC chip may both receive information and communicate information to an RFID and IC chip reader, respectively. A device may include a central processor that communicates data through one or more output devices simultaneously (e.g., an RFID, IC chip, and a dynamic magnetic stripe communications device). The central processor may receive information from one or more input devices simultaneously (e.g., an RFID, IC chip, and a dynamic magnetic stripe communications device). A processor may be coupled to surface contacts such that the processor may perform the processing capabilities of, for example, an EMV chip. The processor may be laminated over and not exposed such that a processor is not exposed on the surface of the device.

A device may be provided with a button in which the activation of the button causes a code to be communicated through a dynamic magnetic stripe communications device (e.g., the subsequent time a read-head detector on the device detects a read-head). The code may be indicative of, for example, a payment option. The code may be received by the device via manual input (e.g., onto buttons of the device).

A dynamic magnetic stripe communications device on a device may be configured to include a permanent magnet placed adjacent to each side of the dynamic magnetic stripe communications device. The dynamic magnetic stripe communications device may be the same size, or slightly narrower, than a typical magnetic stripe located on a payment card. In addition, a shield, for example a copper shield, may be placed below the dynamic magnetic stripe communications device and the magnets.

A second dynamic magnetic stripe communications device may be placed underneath a first dynamic magnetic stripe communications device closer to the posterior side of the device. The first and second dynamic magnetic stripe communications devices may be operable to communicate with magnetic stripe readers with at least two read heads, positioned to receive information from opposite sides of the card. The second dynamic magnetic stripe communications device may be operable to communicate with a read head while the first dynamic magnetic stripe communications device is communicating with a read head on the opposite side of the device. For example, the first and second dynamic magnetic stripe communications devices may be operable to communicate different data

A traditional magnetic stripe may be placed underneath a dynamic magnetic stripe communications device closer to the posterior side of the device. This may be advantageous for communicating with certain magnetic stripe reader device, for example those with at least two read heads, positioned to receive the same or different information from opposite sides of the card. The traditional magnetic stripe may be operable to communicate with a read head while the dynamic magnetic stripe communications device is communicating the same or different data with a read head on the opposite side of the device.

A second dynamic magnetic stripe communications device may also be placed on the same side of a device but above or below a first dynamic magnetic stripe communications device. The first and second dynamic magnetic stripe communications devices may be operable to communicate with magnetic stripe readers with at least two read heads or track heads, positioned to receive information from the same side of the card. The first dynamic magnetic stripe communications device may be operable to communicate with a first read head or first track head while the second dynamic magnetic stripe communications device is communicating with a second read head or a second track head on the same side of the device. For example, in an embodiment, the first dynamic magnetic stripe communications device may be operable to communicate track 1 and track 2 information, while the second dynamic magnetic stripe communications device may be operable to communicate track 3 information.

A traditional magnetic stripe may also be placed on the same side of a device but above or below a dynamic magnetic stripe communications device. This may be advantageous for communicating with certain magnetic stripe reader device, for example those with at least two read heads, positioned to receive information from the same side of the card. The traditional magnetic stripe may be operable to communicate with a first read head while the dynamic magnetic stripe communications device is communicating with a second read head on the same side of the device. For example, in an embodiment, the dynamic magnetic stripe communications device may be operable to communicate track 1 and track 2 information, while the traditional magnetic stripe may be operable to communicate track 3 information.

An electromagnetic generator may be constructed as a stacked assembly of layers where one of the layers includes one or more coils. Inside each coil, one or more strips of a material (e.g., a magnetic or non-magnetic material) may be provided. Outside of the coil, one or more strips of a material (e.g., a magnetic or non-magnetic material) may be provided. For example, three strips of soft magnetic material may be provided in a coil and one strip of hard magnetic material may be stacked exterior of the coil on the side of the coil opposite of the side of the coil utilized to serially communicate magnetic stripe data to a magnetic stripe reader.

An electromagnetic generator may include a coil that may produce an electromagnetic field when current is conducted through the coil. A magnetic material (e.g., a soft-magnetic material) may be located within the coil, which may enhance the electromagnetic field produced by the coil. For example, multiple or several strips of soft-magnetic material may be provided as a stacked assembly inside of the coil.

The one or more strips of material (e.g., a soft-magnetic material) within the coil may be beveled on one or both ends of each strip. Accordingly, for example, a width at one or both ends of each strip may be narrower than a width at the center of each strip. In so doing, a shape of the one or more strips of material may be different at the center of each strip (e.g., rectangular-shaped or square-shaped center portion) as compared to one or both ends of each strip (e.g., triangular-shaped end portion(s)).

A magnetic material (e.g., a hard-magnetic material) may be stacked outside of the coil. The hard-magnetic material may be provided on the side of the coil opposite the side of a coil that communicates to a read head of a magnetic stripe reader. The electromagnetic field produced by the coil may be subjected to a torque that may be induced by the magnetic field generated by the hard-magnetic material stacked outside of the coil.

A shield may be stacked adjacent to the electromagnetic generator. For example, a shield may be provided adjacent to the electromagnetic generator on a side opposite a side that communicates data to a read-head of a magnetic stripe reader. In so doing, the shield may reduce a magnetic bias from a magnetic material located outside of a coil of an electromagnetic generator, as well as reduce an electromagnetic field that may be produced by a coil of an electromagnetic generator. In doing so, magnetic-based signals from an electromagnetic generator may be substantially attenuated on an adjacent side of the electromagnetic generator. Alternatively, in a device configured to communicate with read heads located on opposite sides of the device concurrently, the shield may reduce interference between different communication devices.

The shield may, for example, be an assembly of multiple strips of shielding material that may be bonded together using a flexible adhesive, such as a room-temperature vulcanizing compound (e.g., an RTV silicone). The adhesive may, for example, be cured by exposure to a change in one or more conditions (e.g., a change in atmospheric humidity). Once cured, the flexible adhesive may bond the strips of shielding material together while at the same time remaining flexible. The shield assembly may, for example, be bonded to a magnetic material using an adhesive, such as a pressure-sensitive adhesive, that remains flexible. An additional layer of flexible adhesive may be bonded to the shield assembly. Accordingly, for example, the shield assembly may float between two layers of flexible adhesive to allow the shield assembly to bend and flex while the flexible adhesive stretches and compresses in conformance with movement of the shield assembly.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a card and architecture constructed in accordance with the principles of the present invention;

FIG. 2 is an illustration of a dynamic magnetic stripe communications device constructed in accordance with the principles of the present invention;

FIG. 3 is an illustration of a dynamic magnetic stripe communications device constructed in accordance with the principles of the present invention;

FIG. 4 is an illustration of a dynamic magnetic stripe communications device constructed in accordance with the principles of the present invention; and

FIG. 5 is an illustration of a dynamic magnetic stripe communications device constructed in accordance with the principles of the present invention;

FIG. 6 is an illustration of a dynamic magnetic stripe communications device constructed in accordance with the principles of the present invention; and

FIG. 7 is an illustration of a display constructed in accordance with the principles of the present invention.

### DETAILED DESCRIPTION OF THE INVENTION

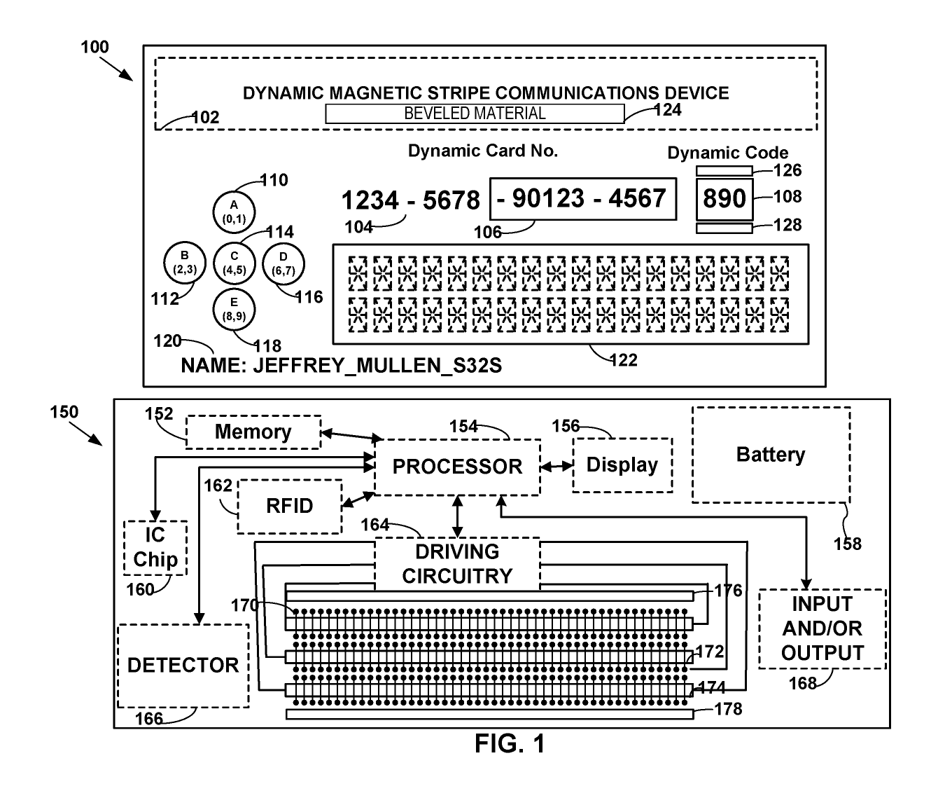

FIG. 1 shows card 100 that may include, for example, a dynamic number that may be entirely, or partially, displayed using a display (e.g., display 106). A dynamic number may include a permanent portion such as, for example, permanent portion 104 and a dynamic portion such as, for example, dynamic portion 106. Card 100 may include a dynamic number having permanent portion 104 and permanent portion 104 may be incorporated on card 100 so as to be visible to an observer of card 100. For example, labeling techniques, such as printing, embossing, laser etching, etc., may be utilized to visibly implement permanent portion 104.

Card 100 may include a second dynamic number that may also be entirely, or partially, displayed via a second display (e.g., display 108). Display 108 may be utilized, for example, to display a dynamic code such as a dynamic security code. Card 100 may also include third display 122 that may be used to display graphical information, such as logos and barcodes. Third display 122 may also be utilized to display multiple rows and/or columns of textual and/or graphical information.

One or more displays within card 100, for example display 108, may be fabricated on the printed circuit board of card 100. For example, a display may comprise e-paper and be fabricated on a flexible printed circuit board.

Persons skilled in the art will appreciate that any one or more of displays 106, 108, and/or 122 may be implemented as a bi-stable display. For example, information provided on displays 106, 108, and/or 122 may be stable in at least two different states (e.g., a powered-on state and a powered-off state). Any one or more of displays 106, 108, and/or 122 may be implemented as a non-bi-stable display. For example, the display is stable in response to operational power that is applied to the non-bi-stable display. Other display types, such as LCD or electro-chromic, may be provided as well.

Card 100 may include a field-effect transistor (“FET”), or array of FETS, operable to control a display (e.g., display 108), for example FETs 126 and 128. FETs 126 and 128 may be utilized, for example, to drive one or more segments of a display, such as the display presenting a dynamic security code. In order to control multiple segments, FETs 126 or 128 may comprise an array of FETs, where each FET controls one segment in the display.

Persons skilled in the art will appreciate that any of the one or more of displays 106, 108, and/or 122 may be controlled by a FET, a plurality of FETs, or a plurality of arrays of FETs. FETs may be used in place of proprietary display drivers to control one or more displays. A person skilled in the art would appreciate that in some instances, a FET or array of FETs may be a smaller or more flexible option when laying out circuitry on a printed circuit board, for example a flexible printed circuit board. In addition, a person skilled in the art would appreciate that using generic circuitry, such as a FET, in place of proprietary circuitry, such as a deice drive, may reduce a manufacturers dependency on a specific parts provider to make a working device.

Card 100 may also include third display 122 that may be used to display graphical information, such as logos and barcodes. Third display 122 may also be utilized to display multiple rows and/or columns of textual and/or graphical information.

Other permanent information, such as permanent information 120, may be included within card 100, which may include user specific information, such as the cardholder's name or username. Permanent information 120 may, for example, include information that is specific to card 100 (e.g., a card issue date and/or a card expiration date). Information 120 may represent, for example, information that includes information that is both specific to the cardholder, as well as information that is specific to card 100.

Card 100 may accept user input data via any one or more data input devices, such as buttons 110-118. Buttons 110-118 may be included to accept data entry through mechanical distortion, contact, or proximity. Buttons 110-118 may be responsive to, for example, induced changes and/or deviations in light intensity, pressure magnitude, or electric and/or magnetic field strength. Such information exchange may be determined and processed by a processor of card 100 as data input.

Dynamic magnetic stripe communications device 102 may be included on card 100 to communicate information to, for example, a read-head of a magnetic stripe reader via, for example, electromagnetic signals. Dynamic magnetic stripe communications device 102 may be formed on a printed circuit board (PCB) as a stacked structure including, for example, an electromagnetic generator including an interior beveled material (e.g., beveled soft-magnetic material 124), an exterior magnet, and a shield. The electromagnetic generator, exterior magnet and shield may be stacked and adhered together using any combination of flexible adhesion components to form dynamic magnetic stripe communications device 102 having elastic and flexible characteristics.

Accordingly, for example, dynamic magnetic stripe communications device 102 may exhibit a flexibility whereby each layer of the stack may move independently of each other layer, while at the same time maintaining adhesion between all layers of the stack. In so doing, individual components of each layer of dynamic magnetic stripe communications device 102 may maintain a correct orientation to each other layer while card 100 may undergo bending and flexing.

A material (e.g., beveled soft-magnetic material 124) and exterior magnets 176 and 178 may, for example, interact to improve performance of dynamic magnetic stripe communications device 102 while dynamic magnetic stripe communications device 102 generates an electromagnetic signal. For example, beveled ends of soft-magnetic material 124 may cause a gradual change (e.g., a gradual increase in the magnetic field magnitude) as a function of a position of a read head of a magnetic stripe reader along dynamic magnetic stripe communications device 102 (e.g., along end portions of dynamic magnetic stripe communications device 102). In addition, exterior magnets 176 and 178 may be operable to bias communications along with width of dynamic magnetic stripe communications device 102, reducing or eliminating cross talk between tracks and maintain a constant magnetic amplitude across the length of dynamic magnetic stripe communications device 102.

Card 100 may, for example, be formed as a laminate structure of two or more layers. Card 100 may, for example, include top and bottom layers of a plastic material (e.g., a polymer). Electronics package circuitry (e.g., one or more printed circuit boards, a dynamic magnetic stripe communications device, a battery, a display, a processor, and buttons) may be sandwiched between top and bottom layers of a laminate structure of card 100. A material (e.g., a polyurethane-based or silicon-based substance) may be applied between top and bottom layers and cured (e.g., solidified) to form card 100 that has a flexible laminate structure.

FIG. 1 shows architecture 150, which may include, for example, one or more processors 154. One or more processors 154 may be configured to utilize external memory 152, internal memory within processor 154, or a combination of external memory 152 and internal memory for dynamically storing information, such as executable machine language, related dynamic machine data, and user input data values.

One or more of the components shown in architecture 150 may be configured to transmit information to processor 154 and/or may be configured to receive information as transmitted by processor 154. For example, one or more displays 156 may be coupled to receive data from processor 154. The data received from processor 154 may include, for example, at least a portion of dynamic numbers and/or dynamic codes. The data to be displayed on the display may be displayed on one or more displays 156.

One or more displays 156 may, for example, be touch sensitive and/or proximity sensitive. For example, objects such as fingers, pointing devices, etc., may be brought into contact with displays 156, or in proximity to displays 156. Detection of object proximity or object contact with displays 156 may be effective to perform any type of function (e.g., transmit data to processor 154). Displays 156 may have multiple locations that are able to be determined as being touched, or determined as being in proximity to an object.

Input and/or output devices may be implemented within architecture 150. For example, integrated circuit (IC) chip 160 (e.g., an EMV chip) may be included within architecture 150, that can communicate information with a chip reader (e.g., an EMV chip reader). Radio frequency identification (RFID) module 162 may be included within architecture 150 to enable the exchange of information with an RFID reader.

Other input and/or output devices 168 may be included within architecture 150, for example, to provide any number of input and/or output capabilities. For example, other input and/or output devices 168 may include an audio device capable of receiving and/or transmitting audible information. Other input and/or output devices 168 may include a device that exchanges analog and/or digital data using a visible data carrier. Other input and/or output devices 168 may include a device, for example, that is sensitive to a non-visible data carrier, such as an infrared data carrier or electromagnetic data carrier.

Electromagnetic field generators 170-174 may communicate one or more tracks of electromagnetic data to read-heads of a magnetic stripe reader. Electromagnetic field generators 170-174 may include, for example, a series of electromagnetic elements, where each electromagnetic element may be implemented as a coil wrapped around one or more materials (e.g., a soft-magnetic material and/or a non-magnetic material). Additional materials, such as a magnet (not shown) and a shield (not shown), may be stacked in proximity to electromagnetic field generators 170-174 using any combination of adhesives (e.g., flexible adhesives), so that the stacked components may be flexed while remaining within a substantially fixed relationship to one another.

Electrical excitation by processor 154 of one or more coils of one or more electromagnetic elements via, for example, driving circuitry 164 may be effective to generate electromagnetic fields from one or more electromagnetic elements. One or more electromagnetic field generators 170-174 may be utilized to communicate electromagnetic information to, for example, one or more read-heads of a magnetic stripe reader.

Timing aspects of information exchange between architecture 150 and the various I/O devices implemented on architecture 150 may be determined by processor 154. One or more detectors 166 may be utilized, for example, to sense the proximity, mechanical distortion, or actual contact, of an external device, which in turn, may trigger the initiation of a communication sequence. The sensed presence or touch of the external device may then be communicated to a controller (e.g., processor 154), which in turn may direct the exchange of information between architecture 150 and the external device. The sensed presence, mechanical distortion, or touch of the external device may be effective to, for example, determine the type of device or object detected.

The detection may include, for example, the detection of a read-head housing of a magnetic stripe reader. In response, processor 154 may activate one or more electromagnetic field generators 170-174 to initiate a communications sequence with, for example, one or more read-heads of a magnetic stripe reader. The timing relationships associated with communications to one or more electromagnetic field generators 170-174 and one or more read-heads of a magnetic stripe reader may be provided through use of the detection of the magnetic stripe reader.

Persons skilled in the art will appreciate that processor 154 may provide user-specific and/or card-specific information through utilization of any one or more of buttons 110-118, RFID 162, IC chip 160, electromagnetic field generators 170-174, and other input and/or output devices 168.

Persons skilled in the art will appreciate that a card (e.g., card 100 of FIG. 1) may, for example, be a self-contained device that derives its own operational power from one or more batteries 158. Furthermore, one or more batteries 158 may be included, for example, to provide operational power to a card for a number of years (e.g., approximately 2-4 years). One or more batteries 158 may be included, for example, as rechargeable batteries.

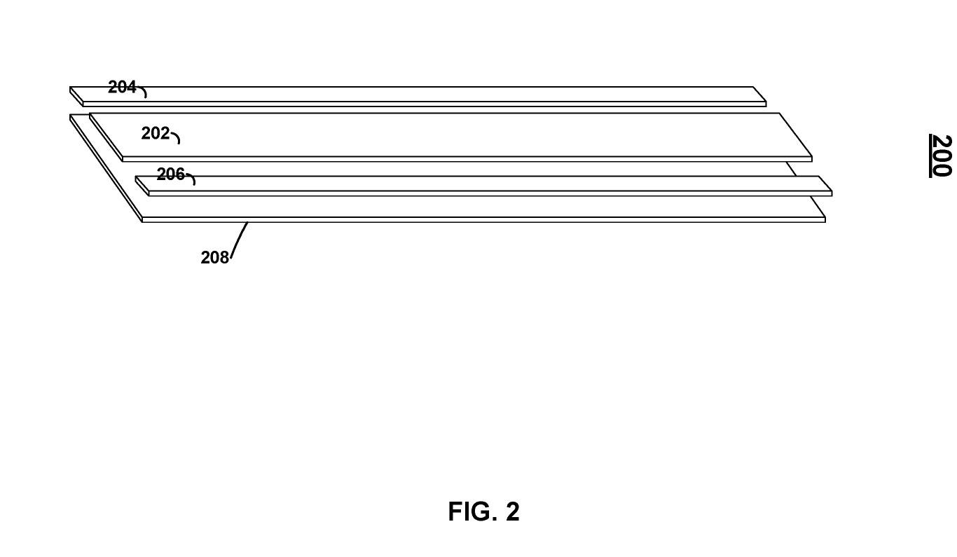

FIG. 2 shows dynamic magnetic stripe 200 that may include a printed circuit board (PCB) and an adhesive layer (not shown) on top of the PCB. The dynamic magnetic stripe 200 may include a dynamic magnetic stripe communications device 202, a first magnet 204, and a second magnet 206. In some embodiments, the dynamic magnetic stripe 200 may also include a shield 208.

Dynamic magnetic stripe communications device 202 may be configured to communicate multiple tracks of electromagnetic data, for example, two tracks of electromagnetic data, by electromagnetic generator to read-heads of a magnetic stripe reader by appropriate control of current conducted by coils within dynamic magnetic stripe communications device 202. Dynamic magnetic stripe communications device 202 may be configured to be narrower than a traditional magnetic stripe. For example the entire width of dynamic magnetic stripe 200, including dynamic magnetic stripe communications device 202, first magnet 204, and second magnet 206 may be approximately equal to the width of a traditional magnetic stripe, for example about 10 mm wide. In an embodiment, dynamic magnetic stripe communications device 202 may be about 5 mm wide. In an embodiment, dynamic magnetic stripe communications device 202 is flexible.

First magnet 204 and second magnet 206 may be operable to bias electromagnetic data communicated by dynamic magnetic stripe communications device 202. For example, first magnet 204 and second magnet 206 may be operable to increase the amplitude of the electromagnetic data communicated by dynamic magnetic stripe communications device 202 to allow a magnetic read head to receive the electromagnetic data. In an embodiment, first magnet 204 and second magnet 206 may be operable to increase the amplitude of the electromagnetic data transmitted by different portions of dynamic magnetic stripe communications device 202 so that a magnetic read head located at a distance, for example, ¼ of an inch, an inch, or two inches away, can receive the data. In some embodiments, the magnetic read head may be located at least ¼ of an inch away, at least one inch away, or at least two inches away. In some embodiments, the magnetic read head may be located less than ¼ of an inch away, less than one inch away, or less than two inches away. In some embodiments, the magnetic read head may be located from about 1/10 of an inch away to about 3 inches away. In an embodiment, first magnet 204 and second magnet 206 may be configured to maintain a constant magnetic field amplitude across the length of dynamic magnetic stripe communications device 202. In an embodiment, first magnet 204 can be configured to bias one track of electromagnetic data and second magnet 206 can be configured to bias a second track of electromagnetic data. In an embodiment, first magnet 204 and second magnet 206 may be configured to reduce or eliminate cross talk between different tracks of the electromagnetic data, for example between a first and a second track of electromagnetic data. In an embodiment, first magnet 204 and second magnet 206 are flexible. In an embodiment, first magnet 204 and second magnet 206 are directly adjacent to dynamic magnetic stripe communications device 202. In an embodiment, first magnet 204 and second magnet 206 are close to but separated from dynamic magnetic stripe communications device 202.

In an embodiment, shield 208 may be operable to inhibit or block electromagnetic data communicated by dynamic magnetic stripe communications device 202. In an embodiment, shield 208 may be operable to inhibit or block electromagnetic effects. For example, this may increase the probability that a card is correctly read by a magnetic stripe reader with two read heads, positioned on opposite sides of the card and offset. In an embodiment, shield 208 comprises a material that is non-magnetic and conductive, for example copper. In an embodiment, shield 208 comprises a material that is magnetic and conductive. In an embodiment, shield 208 comprises a material that is a combination of magnetic and non-magnetic material. In an embodiment, shield 208 is as wide as dynamic magnetic stripe communications device 202. In an embodiment, shield 208 comprises a plurality of shield material, for example a strip of shield material associated with each track. In an embodiment, shield 208 is as wide as dynamic magnetic stripe 200. In an embodiment, shield 208 is wider than dynamic magnetic stripe 200. In an embodiment, shield 208 is flexible.

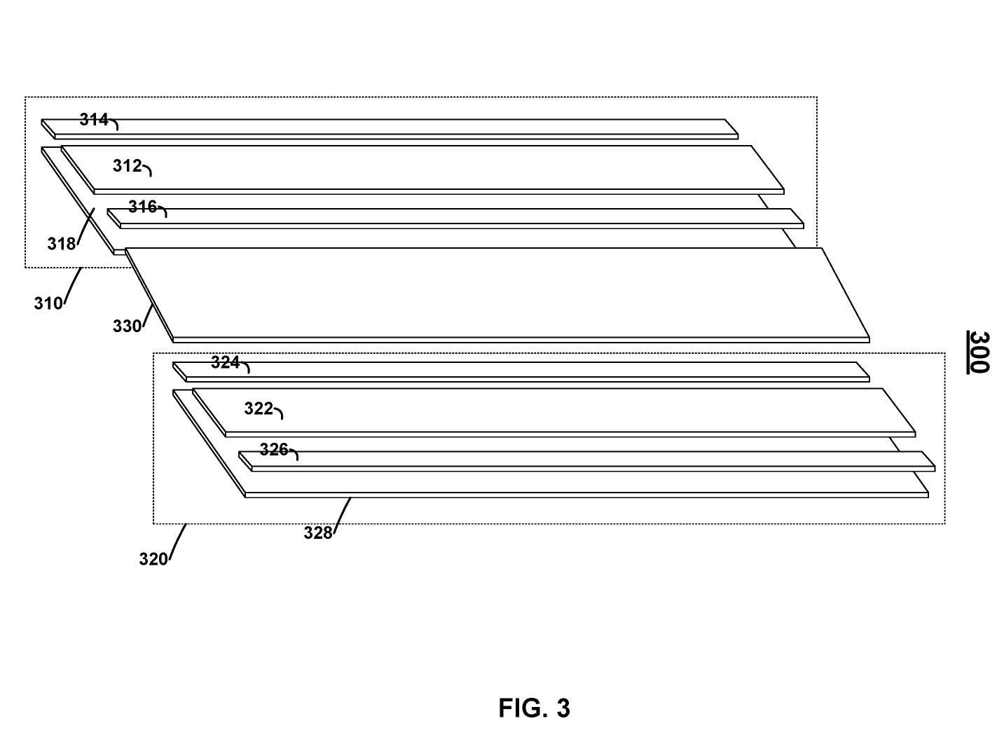

FIG. 3 shows two dynamic magnetic stripes 310 and 320, each of which may include printed circuit board (PCB) and an adhesive layer (not shown) on top of the PCB. In-between dynamic magnetic stripe 310 and dynamic magnetic stripe 320 is shield 330.

Dynamic magnetic stripes 310 and 320 may include dynamic magnetic stripe communications devices 312 and 322, first magnets 314 and 324, and second magnets 316 and 326, as illustrated in FIG. 3. In some embodiments, dynamic magnetic stripe 310 and 320 may also include shields 318 and 328. In an embodiment, each of these elements function in the same manner as described above in relation to their respective dynamic magnetic stripe.

Dynamic magnetic stripe communications devices 312 and 322 may each be configured to communicate multiple tracks of electromagnetic data, for example, two tracks of electromagnetic data, by electromagnetic generator to read-heads of a magnetic stripe reader by appropriate control of current conducted by coils within dynamic magnetic stripe communications devices 312 and 322. Either or both of dynamic magnetic stripe communications devices 312 and 322 may be configured to be narrower than a traditional magnetic stripe. For example the entire width of dynamic magnetic stripe 310, including dynamic magnetic stripe communications device 312, first magnet 314, and second magnet 316 may be approximately equal to the width of a traditional magnetic stripe, for example about 10 mm wide. In an embodiment, either of both of dynamic magnetic stripe communications devices 312 and 322 may be about 5 mm wide. In an embodiment, either or both of dynamic magnetic stripe communications devices 312 and 322 may be flexible.

First magnets 314 and 324 and second magnets 316 and 326 may be operable to bias electromagnetic data communicated by dynamic magnetic stripe communications devices 312 and 322, respectively. For example, first magnet 314 and second magnet 316 may be operable to increase the amplitude of the electromagnetic data communicated by dynamic magnetic stripe communications device 312 to allow a magnetic read head to receive the electromagnetic data. In an embodiment, first magnet 314 and second magnet 316 may be operable to increase the amplitude of the electromagnetic data transmitted by different portions of dynamic magnetic stripe communications device 312 so that a magnetic read head located at a distance, for example, ¼ of an inch, an inch, or two inches away, can receive the data. In some embodiments, the magnetic read head may be located at least ¼ of an inch away, at least one inch away, or at least two inches away. In some embodiments, the magnetic read head may be located less than ¼ of an inch away, less than one inch away, or less than two inches away. In some embodiments, the magnetic read head may be located from about 1/10 of an inch away to about 3 inches away. In an embodiment, first magnet 314 and second magnet 316 may be configured to maintain a constant magnetic field amplitude across the length of dynamic magnetic stripe communications device 312. In an embodiment, first magnet 314 can be configured to bias one track of electromagnetic data and second magnet 316 can be configured to bias a second track of electromagnetic data. In an embodiment, first magnet 314 and second magnet 316 may be configured to reduce or eliminate cross talk between different tracks of the electromagnetic data, for example between a first and a second track of electromagnetic data. In an embodiment, first magnet 314 and second magnet 316 are flexible. In an embodiment, first magnet 314 and second magnet 316 are directly adjacent to dynamic magnetic stripe communications device 312. In an embodiment, first magnet 314 and second magnet 316 are close to but separated from dynamic magnetic stripe communications device 312.

First magnet 324 and second magnet 326 may be operable to increase the amplitude of the electromagnetic data communicated by dynamic magnetic stripe communications device 322 to allow a magnetic read head to receive the electromagnetic data. In an embodiment, first magnet 324 and second magnet 326 may be operable to increase the amplitude of the electromagnetic data transmitted by different portions of dynamic magnetic stripe communications device 322 so that a magnetic read head located at a distance, for example, ¼ of an inch, an inch, or two inches away, can receive the data. In some embodiments, the magnetic read head may be located at least ¼ of an inch away, at least one inch away, or at least two inches away. In some embodiments, the magnetic read head may be located less than ¼ of an inch away, less than one inch away, or less than two inches away. In some embodiments, the magnetic read head may be located from about 1/10 of an inch away to about 3 inches away. In an embodiment, first magnet 324 and second magnet 326 may be configured to maintain a constant magnetic field amplitude across the length of dynamic magnetic stripe communications device 322. In an embodiment, first magnet 324 can be configured to bias one track of electromagnetic data and second magnet 326 can be configured to bias a second track of electromagnetic data. In an embodiment, first magnet 324 and second magnet 326 may be configured to reduce or eliminate cross talk between different tracks of the electromagnetic data, for example between a first and a second track of electromagnetic data. In an embodiment, first magnet 324 and second magnet 326 are flexible. In an embodiment, first magnet 324 and second magnet 326 are directly adjacent to dynamic magnetic stripe communications device 322. In an embodiment, first magnet 324 and second magnet 326 are close to but separated from dynamic magnetic stripe communications device 322.

In an embodiment, the first magnet 324 and the second magnet 316 may be a single magnet, where shield 330 (discussed below) is not present. A person skilled in the art would understand that such a configuration may be easier to manufacture by eliminating any magnetic interaction between first magnet 324 and the second magnet 316. In a further embodiment, the single magnet may be operable to bias both dynamic magnetic stripe communications devices 312 and 322.

In an embodiment, shield 330 is placed between dynamic magnetic stripes 310 and 320. In an embodiment, shield 330 may be operable to inhibit or block electromagnetic data communicated by dynamic magnetic stripe communication devices 312 and 322. In an embodiment, shield 330 may be operable to inhibit or block the electromagnetic data. In an embodiment, shield 330 comprises a material that is non-magnetic and conductive, for example copper. In an embodiment, shield 330 comprises a material that is magnetic and conductive. In an embodiment, shield 330 comprises a material that is a combination of magnetic and non-magnetic material. In an embodiment, shield 330 is flexible.

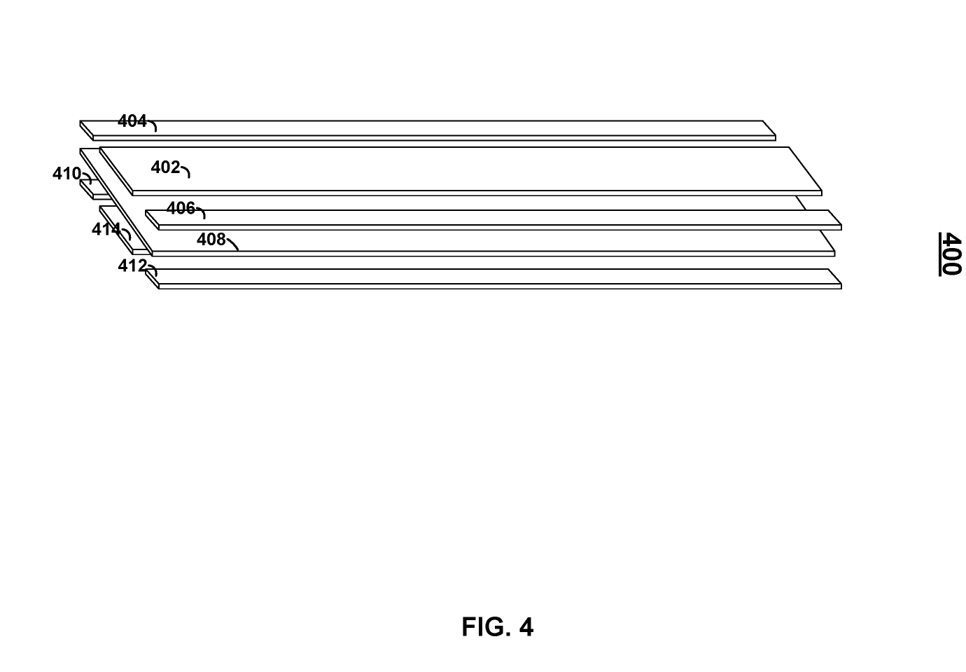

FIG. 4 illustrates a device containing two dynamic magnetic stripes stacked within the device 400, each operable to communicate with read heads located proximate to opposite sides of the device. In an embodiment, the first dynamic magnetic stripe comprises a dynamic magnetic stripe communications device 402, a first magnet 404, and a second magnet 406 and the second dynamic magnetic stripe comprises a dynamic magnetic stripe communications device 414, a first magnet 410, and a second magnet 412.

Dynamic magnetic stripe communications devices 402 and 414 may be configured to communicate multiple tracks of electromagnetic data, for example, two tracks of electromagnetic data, by electromagnetic generator to read-heads of a magnetic stripe reader by appropriate control of current conducted by coils within dynamic magnetic stripe communications devices 402 and 414. Dynamic magnetic stripe communications devices 402 and 414 may be configured to be narrower than a traditional magnetic stripe. For example the entire width of each dynamic magnetic stripe, including dynamic magnetic stripe communications devices 402 and 414, first magnets 404 and 410, and second magnet 406 and 412 may be approximately equal to the width of a traditional magnetic stripe, for example about 10 mm wide. In an embodiment, dynamic magnetic stripe communications devices 402 and 414 may be about 5 mm wide. In an embodiment, dynamic magnetic stripe communications devices 402 and 414 is flexible.

First magnets 404 and 410 and second magnets 406 and 412 may be operable to bias electromagnetic data communicated by dynamic magnetic stripe communications devices 402 and 414. For example, first magnets 404 and 410 and second magnets 406 and 412 may be operable to increase the amplitude of the electromagnetic data communicated by dynamic magnetic stripe communications devices 402 and 414 to allow a magnetic read head to receive the electromagnetic data. In an embodiment, first magnets 404 and 410 and second magnets 406 and 412 may be operable to increase the amplitude of the electromagnetic data transmitted by different portions of dynamic magnetic stripe communications devices 402 and 414 so that a magnetic read head located at a distance, for example, ¼ of an inch, an inch, or two inches away, can receive the data. In some embodiments, the magnetic read head may be located at least ¼ of an inch away, at least one inch away, or at least two inches away. In some embodiments, the magnetic read head may be located less than ¼ of an inch away, less than one inch away, or less than two inches away. In some embodiments, the magnetic read head may be located from about 1/10 of an inch away to about 3 inches away. In an embodiment, first magnets 404 and 410 and second magnets 406 and 412 may be configured to maintain a constant magnetic field amplitude across the length of dynamic magnetic stripe communications devices 402 and 414. In an embodiment, first magnets 404 and 410 can be configured to bias one track of electromagnetic data and second magnets 406 and 412 can be configured to bias a second track of electromagnetic data. In an embodiment, first magnets 404 and 410 and second magnets 406 and 412 may be configured to reduce or eliminate cross talk between different tracks of the electromagnetic data, for example between a first and a second track of electromagnetic data. In an embodiment, first magnets 404 and 410 and second magnets 406 and 412 are flexible. In an embodiment, first magnets 404 and 410 and second magnets 406 and 412 are directly adjacent to dynamic magnetic stripe communications devices 402 and 414, respectively. In an embodiment, first magnets 404 and 410 and second magnets 406 and 412 are close to but separated from their respective dynamic magnetic stripe communications devices 402 and 414.

In an embodiment, shield 408 may be operable to inhibit or block electromagnetic data communicated by dynamic magnetic stripe communications device 402. In an embodiment, shield 408 may be operable to inhibit or block electromagnetic effects. For example, this may increase the probability that a card is correctly read by a magnetic stripe reader with two read heads, positioned on opposite sides of the card and offset. In an embodiment, shield 408 comprises a material that is non-magnetic and conductive, for example copper. In an embodiment, shield 408 comprises a material that is magnetic and conductive. In an embodiment, shield 408 comprises a material that is a combination of magnetic and non-magnetic material. In an embodiment, shield 408 is as wide as dynamic magnetic stripe communications devices 402 or 414. In an embodiment, shield 408 comprises a plurality of shield material, for example a strip of shield material associated with each track. In an embodiment, shield 408 is as wide as one or both dynamic magnetic stripes. In an embodiment, shield 408 is wider than one or both dynamic magnetic stripes. In an embodiment, shield 408 is flexible.

In an embodiment, first magnets 404 and 410 may be a single magnet, e.g., to make handling and manufacturing easier. For example, using a single magnet may eliminate issue of manufacturing a device with two magnets whose magnetic poles are oriented in the same direction in proximity of each other. In an embodiment, a single first magnet may be configured to maintain a constant magnetic field amplitude across the length of dynamic magnetic stripe communications devices 402 and 414. In an embodiment, a single first magnet can be configured to bias one track of electromagnetic data in each of dynamic magnetic stripe communications devices 402 and 414. In an embodiment, a single first magnet may be configured to reduce or eliminate cross talk between different tracks of the electromagnetic data within dynamic magnetic stripe communications devices 402 and 414.

In an embodiment, second magnets 406 and 412 may be a single magnet, e.g., to make handling and manufacturing easier. For example, using a single magnet may eliminate issue of manufacturing a device with two magnets whose magnetic poles are oriented in the same direction in proximity of each other. In an embodiment, a single second magnet may be configured to maintain a constant magnetic field amplitude across the length of dynamic magnetic stripe communications devices 406 and 412. In an embodiment, a single second magnet can be configured to bias one track of electromagnetic data in each of dynamic magnetic stripe communications devices 406 and 412. In an embodiment, a single second magnet may be configured to reduce or eliminate cross talk between different tracks of the electromagnetic data within dynamic magnetic stripe communications devices 406 and 412.

In some embodiments, shield 408 may be placed between dynamic magnetic stripe communications devices 402, first magnets 404, and/or second magnets 406 and dynamic magnetic stripe communications devices 414, first magnets 410, and/or second magnets 412. In an embodiment, each of these elements function in the same manner as described above in relation to their respective dynamic magnetic stripe.

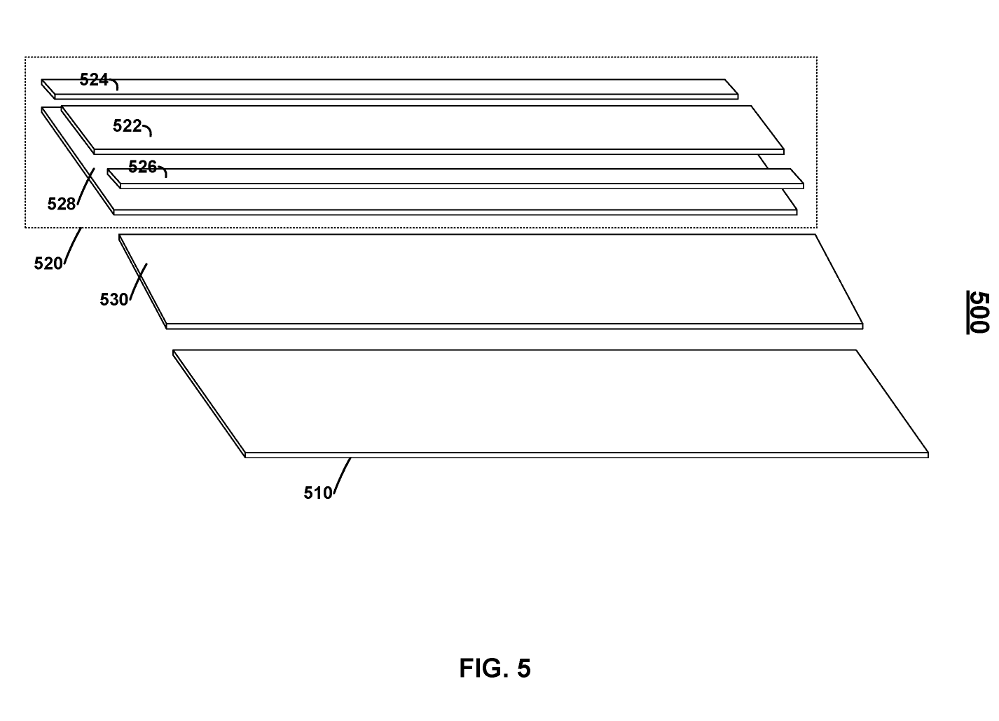

FIG. 5 shows a traditional magnetic stripe 510 and a dynamic magnetic stripe 520, each of which may include printed circuit board (PCB) and an adhesive layer (not shown) on top of the PCB. In-between traditional magnetic stripe 510 and dynamic magnetic stripe 520 is shield 530.

In an embodiment, traditional magnetic stripe 510 is similar to magnetic stripes found on traditional cards, for example static credit cards.

In an embodiment, dynamic magnetic stripe 520 is similar to dynamic magnetic stripe 200 illustrated in FIG. 2 and discussed above. Dynamic magnetic stripe 520 may include dynamic magnetic stripe communications device 522, first magnet 524, and second magnet 526, as illustrated in FIG. 5. In some embodiments, dynamic magnetic stripe 520 may also include shield 528.

Dynamic magnetic stripe communications device 522 may be configured to communicate multiple tracks of electromagnetic data, for example, two tracks of electromagnetic data, by electromagnetic generator to read-heads of a magnetic stripe reader by appropriate control of current conducted by coils within dynamic magnetic stripe communications device 522. Dynamic magnetic stripe communications device 522 may be configured to be narrower than a traditional magnetic stripe. For example the entire width of dynamic magnetic stripe 520, including dynamic magnetic stripe communications device 522, first magnet 524, and second magnet 526 may be approximately equal to the width of a traditional magnetic stripe, for example about 10 mm wide. In an embodiment, dynamic magnetic stripe communications device 522 may be about 5 mm wide. In an embodiment, dynamic magnetic stripe communications device 522 is flexible.

First magnet 524 and second magnet 526 may be operable to bias electromagnetic data communicated by dynamic magnetic stripe communications device 522. For example, first magnet 524 and second magnet 526 may be operable to increase the amplitude of the electromagnetic data communicated by dynamic magnetic stripe communications device 522 to allow a magnetic read head to receive the electromagnetic data. In an embodiment, first magnet 524 and second magnet 526 may be operable to increase the amplitude of the electromagnetic data transmitted by different portions of dynamic magnetic stripe communications device 522 so that a magnetic read head located at a distance, for example, ¼ of an inch, an inch, or two inches away, can receive the data. In some embodiments, the magnetic read head may be located at least ¼ of an inch away, at least one inch away, or at least two inches away. In some embodiments, the magnetic read head may be located less than ¼ of an inch away, less than one inch away, or less than two inches away. In some embodiments, the magnetic read head may be located from about 1/10 of an inch away to about 3 inches away. In an embodiment, first magnet 524 and second magnet 526 may be configured to maintain a constant magnetic field amplitude across the length of dynamic magnetic stripe communications device 522. In an embodiment, first magnet 524 can be configured to bias one track of electromagnetic data and second magnet 526 can be configured to bias a second track of electromagnetic data. In an embodiment, first magnet 524 and second magnet 526 may be configured to reduce or eliminate cross talk between different tracks of the electromagnetic data, for example between a first and a second track of electromagnetic data. In an embodiment, first magnet 524 and second magnet 526 are flexible. In an embodiment, first magnet 524 and second magnet 526 are directly adjacent to dynamic magnetic stripe communications device 522. In an embodiment, first magnet 524 and second magnet 526 are close to but separated from dynamic magnetic stripe communications device 522.

In an embodiment, shield 528 may be operable to inhibit or block electromagnetic data communicated by dynamic magnetic stripe communications device 522. In an embodiment, shield 528 may be operable to inhibit or block electromagnetic effects. For example, this may increase the probability that a card is correctly read by a magnetic stripe reader with two read heads, positioned on opposite sides of the card and offset. In an embodiment, shield 528 comprises a material that is non-magnetic and conductive, for example copper. In an embodiment, shield 528 comprises a material that is magnetic and conductive. In an embodiment, shield 528 comprises a material that is a combination of magnetic and non-magnetic material. In an embodiment, shield 528 is as wide as dynamic magnetic stripe communications device 522. In an embodiment, shield 528 comprises a plurality of shield material, for example a strip of shield material associated with each track. In an embodiment, shield 528 is as wide as dynamic magnetic stripe 520. In an embodiment, shield 528 is wider than dynamic magnetic stripe 520. In an embodiment, shield 528 is flexible.

In an embodiment, shield 530 is placed between traditional magnetic stripe 510 and dynamic magnetic stripes 520. In an embodiment, shield 530 may be operable to inhibit or block electromagnetic data communicated by dynamic magnetic stripe communication device 522. In an embodiment, shield 530 may be operable to inhibit or block any electromagnetic data.

In an embodiment, shield 530 comprises a material that is non-magnetic and conductive, for example copper. In an embodiment, shield 530 is flexible.

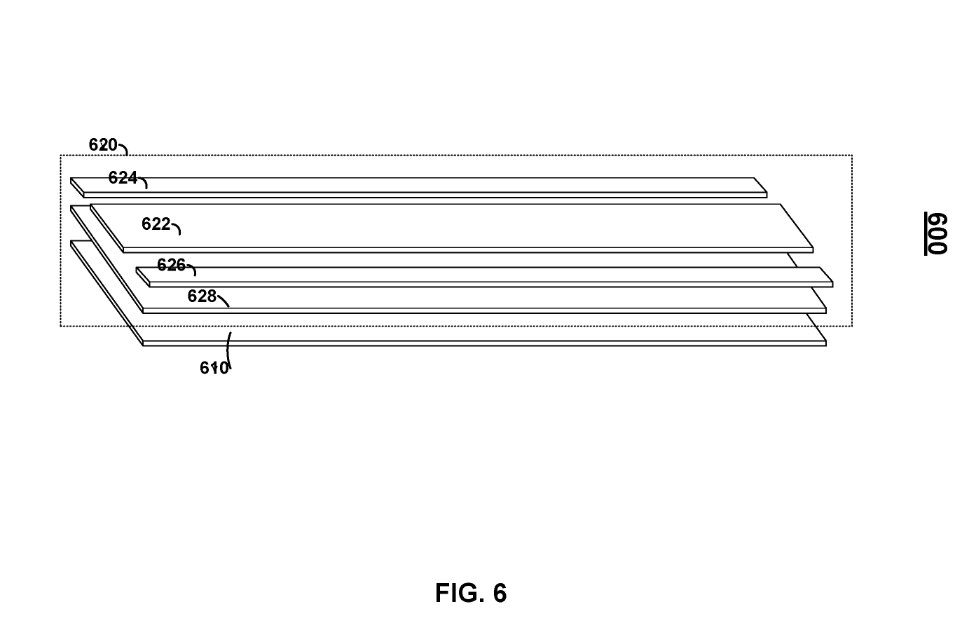

FIG. 6 shows a traditional magnetic stripe 610 and a dynamic magnetic stripe 620, each of which may include printed circuit board (PCB) and an adhesive layer (not shown) on top of the PCB.

In an embodiment, traditional magnetic stripe 610 is similar to magnetic stripes found on traditional cards, for example static credit cards.

In an embodiment, dynamic magnetic stripe 620 is similar to dynamic magnetic stripe 200 illustrated in FIG. 2 and discussed above. Dynamic magnetic stripe 620 may include dynamic magnetic stripe communications device 622, first magnet 624, and second magnet 626, as illustrated in FIG. 6. In some embodiments, dynamic magnetic stripe 620 may also include shield 628.

Dynamic magnetic stripe communications device 622 may be configured to communicate multiple tracks of electromagnetic data, for example, two tracks of electromagnetic data, by electromagnetic generator to read-heads of a magnetic stripe reader by appropriate control of current conducted by coils within dynamic magnetic stripe communications device 622. Dynamic magnetic stripe communications device 622 may be configured to be narrower than a traditional magnetic stripe. For example the entire width of dynamic magnetic stripe 620, including dynamic magnetic stripe communications device 622, first magnet 624, and second magnet 626 may be approximately equal to the width of a traditional magnetic stripe, for example about 10 mm wide. In an embodiment, dynamic magnetic stripe communications device 622 may be about 5 mm wide. In an embodiment, dynamic magnetic stripe communications device 622 is flexible.

First magnet 624 and second magnet 626 may be operable to bias electromagnetic data communicated by dynamic magnetic stripe communications device 622. For example, first magnet 624 and second magnet 626 may be operable to increase the amplitude of the electromagnetic data communicated by dynamic magnetic stripe communications device 622 to allow a magnetic read head to receive the electromagnetic data. In an embodiment, first magnet 624 and second magnet 626 may be operable to increase the amplitude of the electromagnetic data transmitted by different portions of dynamic magnetic stripe communications device 622 so that a magnetic read head located at a distance, for example, ¼ of an inch, an inch, or two inches away, can receive the data. In some embodiments, the magnetic read head may be located at least ¼ of an inch away, at least one inch away, or at least two inches away. In some embodiments, the magnetic read head may be located less than ¼ of an inch away, less than one inch away, or less than two inches away. In some embodiments, the magnetic read head may be located from about 1/10 of an inch away to about 3 inches away. In an embodiment, first magnet 204 and second magnet 626 may be configured to maintain a constant magnetic field amplitude across the length of dynamic magnetic stripe communications device 622. In an embodiment, first magnet 624 can be configured to bias one track of electromagnetic data and second magnet 626 can be configured to bias a second track of electromagnetic data. In an embodiment, first magnet 624 and second magnet 626 may be configured to reduce or eliminate cross talk between different tracks of the electromagnetic data, for example between a first and a second track of electromagnetic data. In an embodiment, first magnet 624 and second magnet 626 are flexible. In an embodiment, first magnet 624 and second magnet 626 are directly adjacent to dynamic magnetic stripe communications device 622. In an embodiment, first magnet 624 and second magnet 626 are close to but separated from dynamic magnetic stripe communications device 622.

In an embodiment, shield 628 may be operable to inhibit or block electromagnetic data communicated by dynamic magnetic stripe communications device 622. In an embodiment, shield 628 may be operable to inhibit or block electromagnetic effects. For example, this may increase the probability that a card is correctly read by a magnetic stripe reader with two read heads, positioned on opposite sides of the card and offset. In an embodiment, shield 628 comprises a material that is non-magnetic and conductive, for example copper. In an embodiment, shield 628 comprises a material that is magnetic and conductive. In an embodiment, shield 628 comprises a material that is a combination of magnetic and non-magnetic material. In an embodiment, shield 628 is as wide as dynamic magnetic stripe communications device 622. In an embodiment, shield 628 comprises a plurality of shield material, for example a strip of shield material associated with each track. In an embodiment, shield 628 is as wide as dynamic magnetic stripe 620. In an embodiment, shield 628 is wider than dynamic magnetic stripe 620. In an embodiment, shield 628 is flexible.

In an embodiment, shield 628 may be operable to inhibit or block electromagnetic data communicated by dynamic magnetic stripe communication device 622 and/or traditional magnetic stripe 610. In an embodiment, shield 628 may be operable to inhibit or block any electromagnetic data. In an embodiment, shield 628 comprises a material that is non-magnetic and conductive, for example copper. In an embodiment, shield 628 comprises a material that is magnetic and conductive. In an embodiment, shield 628 comprises a material that is a combination of magnetic and non-magnetic material. In an embodiment, shield 628 is flexible.

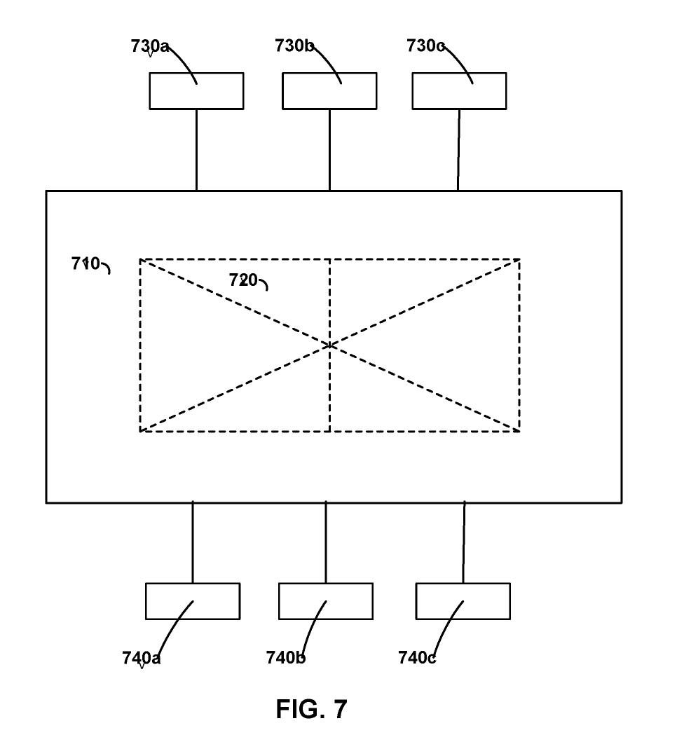

FIG. 7 shows a display region 700 including a display area 710, a display element 720, a first array of segment control circuits 730a-730c, and a second array of segment control circuits 740a-740c.

Display area 710 may be configured to display one or more display elements, for example display element 720. Display area 710 may be fabricated directly onto a printed circuit board, for example a flexible printed circuit board. In an embodiment display area 710 comprises e-paper.

Display element 720 may comprise multiple segments, for example 6 or 8 segments. Display element 720 may be configured to allow each segment to be controlled independently. For example, display element 720 may comprise one or more electrical connections for each segment. In an embodiment, these electrical connections are electrically connected to associated connection on display area 710.

The first array of segment control circuits 730a-730c and the second array of segment control circuits 740a-740c may each be configured to control one or more segments of display element 720 (that may comprise one or more display elements). In an embodiment each segment control circuit is electrically connected to and controls one segment of display element 720. In an embodiment, all segment control circuits are located on one side of display area 710. In another embodiment, the segment control elements are located proximate to different sides of display area 710. In an embodiment, each segment control circuit is a FET (a field-effect transistor).

In an embodiment, display region 700 may also include a voltage regulation circuit (not shown) that may regulate the voltage provided to display area 710, display element 720, or segment control circuits 730a-730c and 740a-740c. In an embodiment, the voltage regulation circuit may increase or decrease the voltage provided by a battery. In an embodiment, the voltage regulation circuit may also include a charge pump.

In an embodiment, display region 700 is part of a payment card device, for example a dynamic credit card. In an embodiment display region 700 may display a portion of the credit card number, the entire credit card number, a dynamic credit verification code, a dynamic credit verification value, expiration date, etc.

A person skilled in the art would appreciate that the use of commodity components, for example e-paper and FETs, is advantageous in comparison to traditional display drivers and prefabricated display modules. For example, a person skilled in the art would appreciate that the use of commodity components reduced the dependency of manufactures on suppliers of specialized products. In addition, a person skilled in the art would appreciate that the use of a multiple segment control circuits in comparison with a single display driver allows for additional flexibility with regard to placement of components and wire routing.

In addition, a person skilled in the art would appreciate that the use of a display area that can be fabricated as part of a printed circuit board is advantageous in comparison to using external display modules. For example, a person skilled in the art would appreciate that a display area fabricated as part of a printed circuit board would be less vulnerable to separating when a printed circuit board is flexed or bent.

Persons skilled in the art will appreciate that the present invention is not limited to only the embodiments described. Instead, the present invention more generally involves dynamic information. Persons skilled in the art will also appreciate that the apparatus of the present invention may be implemented in ways other than those described herein. All such modifications are within the scope of the present invention, which is limited only by the claims that follow.

What is claimed is:

1. A device, comprising:
a dynamic magnetic stripe emulator operable to transmit magnetic stripe information;
a first magnet adjacent to a first side of the dynamic magnetic stripe emulator; and
a second magnet adjacent to a second side of the dynamic magnetic stripe emulator.

2. The device of claim 1, wherein the surface of the dynamic magnetic stripe emulator is in the same plane as the surface of the device.

3. The device of claim 1, wherein the first magnet, the second magnet, and the dynamic magnetic stripe emulator is in the same plane as the surface of the device.

4. The device of claim 1, wherein the first side and the second side are opposite sides of the dynamic stripe emulator.

5. The device of claim 1, wherein the first magnet is operable to bias the dynamic magnetic stripe emulator.

6. The device of claim 1, wherein the first magnet and the second magnet are operable to bias the dynamic magnetic stripe emulator.

7. The device of claim 1, wherein the first magnet is operable to bias a first track of the magnetic stripe information transmitted by the dynamic magnetic stripe emulator.

8. The device of claim 1, wherein the first magnet is operable to bias a first track of the magnetic stripe information transmitted by the dynamic magnetic stripe emulator and the second magnet is operable to bias a second track of the magnetic stripe information transmitted by the dynamic magnetic stripe emulator.

9. The device of claim 1, wherein the dynamic magnetic stripe emulator is narrower than a traditional magnetic stripe.

10. The device of claim 1, further comprising a shield.

11. The device of claim 1, further comprising a shield wherein the shield is on the opposite side of the dynamic magnetic stripe emulator from a surface of the device closest to the dynamic magnetic stripe emulator.

12. The device of claim 1, further comprising a shield wherein the shield is on the opposite side of the dynamic magnetic stripe emulator, first magnet, and second magnet from a surface of the device closest to the dynamic magnetic stripe emulator.

13. The device of claim 1, further comprising a shield operable to block electromagnetic data.
